(19) United States
(12) Patent Application Publication
(10) Pub. No.: US 2026/0225172 A1
(43) Pub. Date: Aug. 6, 2026

(54) WELDING APPARATUS AND METHOD

(71) Applicant: HUYS INDUSTRIES LIMITED, Etobicoke (CA)

(72) Inventors: SERKAN KUNT, Etobicoke (CA); KEVIN R. CHAN, North York (CA)

(21) Appl. No.: 19/042,184

(22) Filed: Jan. 31, 2025

(51) Int. Cl. B23K 9/04

(52) U.S. Cl. CPC B23K 9/04

(57) ABSTRACT

A welding electrode holding apparatus such as may be used in an ESD process has a stationary base. A rotating carriage is mounted to the base. The rotating carriage spins a long ESD welding electrode. The welding electrode can advance through a set of brushes and through a leading end guide to encounter a workpiece. The bushes are connected to an ESD power supply, and they engage the welding electrode. Since the bushes are between the carriage and the workpiece, the length of the current path through the electrode is fixed, and hence the resistance in the electrode is constant even as it is being incrementally consumed. No electricity is passing through the carriage bearings. A sensor monitors the process to see when it is time to change the welding electrode for a new one.

### FIELD OF THE INVENTION

This invention relates to the field of Electro-Spark Discharge welding equipment.

### BACKGROUND OF THE INVENTION

In Electro Spark Discharge (ESD) welding or coating processes it is typical to use a welding electro handle that has a collet system in which a rod of ESD material is mounted. The rod is typically made of a sintered alloy of the alloy desired for deposition. The collect is a form of clamp that rigidly grips the near end of the welding rod. The collet itself is mounted to rotate, so that the ESD rod rotates about its long axis during deposition. Additionally, the electrical current applied to the welding rod in the successive ESD discharge pulses is applied through the collet. Given that ESD sintered welding rods are quite narrow, and that they are spinning while intermittently contacting the workpiece, the welding rods are typically quite short – typically initially 3 or 4 inches. As the deposition process continues, the rods is progressively eaten away by successive discharge pulses. When the rod has been consumed down to a short stub, processing stops. The operator then loosens the collect with wrenches, and inserts another short welding rod. The stub of the previous rod, which is too short to use, is then thrown away.

This procedure is less than optimal for a number of reasons. First, the changing of rods occurs quite frequently, such that the proportion of down-time for the changing of welding rods is quite significant as a proportion of total working time. In general, it would be better to have fewer interruptions in the process, and for those interruptions to be shorter. This is particularly so where the electrode holder is not hand held, but rather is held on the end of a robot arm, and where replacement of the welding rod requires the entire robot to be taken out of service for the duration of the installation of a replacement rod. Second, the proportion of sintered welding rods that remain in the discarded stub is quite high relative to the total amount of the short welding rods. Third, related to that, ESD is often used to make a weld with materials that might usually be considered difficult to weld together – whether directly or by the use of an intermediate coating layer. Often enough, the ESD deposition alloys are relatively exotic materials, and the sintered rods may be quite expensive. It is therefore not optimal to be discarding a relatively high proportion of that material as unusable left-over stubs. Fourth, in the use of a rotating collet, the electrical current passes through the collect itself. This may not be helpful for long part life.

### SUMMARY OF THE INVENTION

In an aspect of the invention there is a welding electrode holding apparatus operable to accommodate advance of an ESD welding electrode rod during operation on a workpiece. The apparatus has a head and a carriage mounted co-operably with the head. The carriage has a grip in which to secure an end of an ESD welding electrode. The carriage defines a pathway. The grip is movable relative to the pathway, and is constrained to follow the pathway. There is a drive mounted to rotate the carriage. The carriage is operable to transmit rotation to the grip and thereby to the ESD welding rod when the ESD welding rod is mounted in the grip. The head has a guide that admits passage of the ESD welding rod. The head has a first brush through which electrical current from a power supply is passed to the ESD welding rod.

In a feature of that aspect, the carriage is supported in a pair of spaced apart bearings permitting rotation thereof about an axis or rotation. During operation, the grip is able to translate axially relative to the axis of rotation. In a further feature, the head has a second brush and the first and second brushes are opposed and are mounted to engage the ESD welding rod. In another feature, there is a respective push pin mounted in opposition to each the brush. In still another feature, the guide is electrically isolated other than through contact with the ESD welding rod. In yet another feature, the apparatus includes a sensor mounted to detect an end of travel advance of the ESD welding rod. In still another feature, the apparatus is biased to urge the ESD welding rod axially toward a workpiece while being rotated in the carriage. In still another feature, the apparatus includes a sight-glass to permit visual observation of consumption of the ESD welding rod during processing. In a further feature, at least one of: (a) the brush lies between the carriage and the workpiece; and (b) the brush lies between the carriage and the guide. In still another feature, when the apparatus is higher than the workpiece, the apparatus is biased by gravity to advance the welding rod. The apparatus has a sensor operable to identify when the ESD welding rod requires replacement. In a yet further feature, at least one of (a) the carriage; and (b) the guide plate, is isolated from electrical ground; and the apparatus includes a fan operable to provide ventilation to the brush.

In another aspect, there is an ESD welding apparatus in which to mount an ESD welding rod for deposition of material on a workpiece. The apparatus has an electrical current path length through the ESD welding rod to the workpiece that is constant notwithstanding incremental consumption of the ESD welding rod.

In a feature of that aspect of the invention, in operation, electrical resistance in the welding rod is constant. In another feature, the apparatus has a rotating mounting for the ESD welding rod. The rotating mounting is isolated from electrical ground. In another feature the apparatus includes a carriage and a set of brushes. In use the welding rod advances through the carriage toward the workpiece. The set of brushes engage the welding rod at a location between the carriage and the workpiece. In a further feature, the apparatus includes an escape by which to extract the remainder of the ESD welding rod after consumption of a predominant portion thereof. The escape is located between the carriage and the workpiece.

In another aspect of the invention, there is a method of ESD deposition of welding material from an ESD welding rod on a workpiece. The method includes maintaining a constant electrical current length in the ESD welding rod while it is being consumed. In a feature of that method, the method includes spinning the ESD welding rod in a carriage. The carriage is provided with a grip therein that fastens to the ESD welding rod, and the method includes keeping the grip otherwise isolated from electrical ground.

In another aspect of the invention, there is any apparatus substantially as shown or described herein, in whole or in part.

### BRIEF DESCRIPTION OF THE DRAWINGS

These aspects and other features of the invention can be understood with the aid of the following illustrations of a number of exemplary, and non-limiting, embodiments of the principles of the invention in which:

FIG. 1 shows a perspective view of a welding apparatus seen from the welding rod end, in front, and above;

FIG. 2 shows a perspective view of the welding apparatus of FIG. 1, seen from the opposite side, the far end, and slightly above;

FIG. 3 shows a top view of the welding apparatus of FIG. 1;

FIG. 4 shows a side view of the welding apparatus of FIG. 1;

FIG. 5 is a view on section ‘5 – 5’ of FIG. 3;

FIG. 6 is a view on section ‘6 – 6’ of FIG. 4;

FIG. 7 shows an alternate embodiment to section ‘6 – 6’ of FIG. 4; and

FIG. 8 shows an alternate embodiment to section ‘5 – 5’ corresponding to the embodiment of FIG. 7.

### DETAILED DESCRIPTION

The description that follows, and the embodiments described therein, are provided by way of illustration of an example, or examples, of particular embodiments incorporating one or more of the principles, aspects, and features of the present invention. These examples are provided for the purposes of explanation, and not of limitation, of those principles and of the invention. In the description, like parts are marked throughout the specification and the drawings with the same respective reference numerals. The drawings may be understood to be to scale and in proportion unless otherwise noted. The wording used herein is intended to include both singular and plural where such would be understood, and to include synonyms or analogous terminology to the terminology used, and to include equivalents thereof in English or in any language into which this specification many be translated, without being limited to specific words or phrases.

The scope of the invention herein is defined by the claims. Though the claims are supported by the description, they are not limited to any particular example or embodiment, and any claim may encompass processes or apparatus other than the specific examples described below. Other than as indicated in the claims themselves, the claims are not limited to apparatus or processes having all the features of any one apparatus or process described below, or to features common to multiple or all the apparatus described below. It is possible that an apparatus, feature, or process described below is not an embodiment of any claimed invention.

In this description, a cylindrical polar frame of reference may be used. The description pertains to welding heads, welding rods, and so on, that are formed as bodies of revolution about a central axis. In such a frame of reference, the long, or largest, dimension of an object may be considered to extend in the direction of the z-axis, the base of the article, where substantially planar, may be considered to extend in an r-theta plane, and the height of the article may be measured in the vertical or z-direction. Unless noted otherwise, the terms “inside” and “outside”, “inwardly” and “outwardly”, refer to location or orientation relative to the central axis. In this description, when an item, or structure, is indicated as being insulated, such term is understood to mean that the wall has a layer of insulation. In this specification, the commonly used engineering terms “proud”, “flush”, and “shy” may be used to denote items that, respectively, protrude beyond an adjacent element, are level with an adjacent element, or do not extend as far as an adjacent element, the terms corresponding conceptually to the conditions of “greater than”, “equal to” and “less than”.

The terminology used in this specification is thought to be consistent with the customary and ordinary meanings of those terms as they would be understood by a person of ordinary skill in the art in North America. The Applicants expressly exclude all interpretations are inconsistent with this specification, and, in particular, any interpretation of the claims or the specification such as may be made in the USPTO, or in any other Patent Office, other than those interpretations for which express support can be demonstrated in this specification or in objective evidence of record, demonstrating how the terms are used and understood by persons of ordinary skill in the art, or by way of expert evidence of a person or persons of experience in the art.

In this description the terms “non-electrically conductive” or “electrically insulated” may be used. The electrical conductivity of materials may vary by many orders of magnitude, from highly conductive materials, such as pure copper, gold, or aluminum to extremely poor conductors, such as bakelite, ceramics, rubbers, and so on. In context, “non-electrically conductive” and “electrically insulated” may be understood by comparison to the electrical conductivity of the copper electrode base and the copper or copper-alloy electrode tip, which are intended to conduct high electrical current for welding, and less conductive materials or coatings that are intended not to allow sufficient current flow for welding to occur.

Much of this description is made in the context of Electro-Spark Deposition (ESD) welding. The apparatus shown and described herein may be employed for processes that may be termed “Low Energy Welding”, or ultra-low energy welding, of which ESD is an example. Unlike conventional welding, ESD does not rely on continuous electrical current supply, but rather upon the periodic release of charge pulses. That is, whereas there may be 1 kJ of energy used in the heating of a resistance spot weld, or 1kJ to 20kJ of a continuous arc weld, by contrast in an intermittent electrical discharge weld, the amount of energy used in heating at each contact of the electrode to the workpiece may be of the order of 1 or 2 Joules or less (typically 0.2 Joules). The pulse frequency is typically on the order of 200 pulses per second. There is a finite time gap, or dead time, or dwell time between pulses during which there is no current flow. Accordingly, as an ESD welding rod rotates about its axis it makes and breaks electrical contact. With each pulse there is a new spark, and a new micro-deposition of material from the welding rod on the work piece. The welding rod is usually operated at a non-perpendicular angle, i.e., an oblique angle, such that as the welding rod turns it tends to have a conical tip, rather like sharpening a pencil, as successive discharges occur. The coating thickness may be in the range of 0.020” (or less) up to 0.250” or more depending upon materials and the number of passes. It would take many passes to accumulate an ESD deposition of 0.250”. In a low energy welding process, such as ESD, there is no weld pool or puddle, or molten material, and for practical purposes there is no Heat Affected Zone (HAZ). ESD is most often used where either the point of the process is to avoid the creation of a Heat Affected Zone, or where the materials themselves are difficult to weld, or both. The heating has very short time duration, is highly localised, and results in the deposition of only a very small amount of material. While the welding is true welding in terms of the fusion of materials through melting, the small energy input may tend to reduce or substantially eliminate any heat affected zone.

In the past, Low Energy Welding has been a hand-held process, often dependent upon the manual skill and intuition of the operator. However, the apparatus described herein allows a robot, such as a multiple-degree-of-freedom robot, to control the path of coating or welding in the same manner as would be done with an end mill, while retaining the rotation of the welding rod as in a hand-held unit. Using force, current, and motion feedback, the apparatus may adjust electrode stick-out according to the controlled, programmed pattern of direction, angle, and force. The frequency of the electrical supply and the speed of electrode rotation are all adjustable (or fixed) as welding occurs. Spindle speed is known, because it is monitored, and can be adjusted in real-time, thereby tending to permit a more consistent processing of a workpiece, and promoting consistency of processing from workpiece to workpiece.

Furthermore, being an ESD coating, the coating thickness is determined by controlling the quantity of deposited materials. The coating may include a first coating layer made of a first material, or first alloy, and a second coating layer or second coating alloy that may be of the same or a different material or different composition of matter. For example, the final coating may not be compatible with the parent material, or may simply be difficult to weld successfully to the parent material. So the first material (or alloy) is used to make a first layer compatible with the material of the workpiece substrate. The second material (or alloy) may be compatible with the first material, and so on. Or it may be that successive layers of one material may be built up in increasing thickness by subsequent processing. Although reference is made to a first layer and a second layer, there may be more than two layers.

A premise of ESD coating is that the work piece is, or work pieces are, electrically conductive, and connected to one terminal of the welding power supply. That is, a first terminal of the power supply is connected by a conductor such as wire or cable to welding applicator defined by an electrode holder such as described hereinbelow. A second terminal is connected to the workpiece, or to an electrically conductive jig or workpiece holder in which the workpiece is held in electrically conductive engagement during the coating process. The second terminal is of opposite polarity to the first terminal. Whether directly or indirectly, the workpiece and the power supply are in electrical connection to form a continuous path for electric current. Similarly, as noted, the other terminal of the power supply is connected to welding electrode holder to form a continuous electrical path to welding the rod of opposite electrical polarity to work piece such that an arc will be formed between them when they approach. During operation the applicator is subject to rotation of welding rod, as noted above.

During ESD, the tip of welding electrode rod is in intermittent electrical contact with the work surface. When current is flowing, an arc forms and welding rod material is deposited in a molten form on the workpiece surface. There may also be local heating due to the electric current discharge. Typically, the electrical discharge step involves switching current on and off over relatively short time periods on the order of one or two milliseconds. This switching is achieved with programming of the power supply. Similarly, the dwell time when electrical discharge current is off may be quite short, again, of the order of one or two, or a few, milliseconds. The switching “On” and “Off” may occur rapidly and repeatedly such that while discharges may be distinct, and cyclic, to a human observer it may appear continuous.

In some instances, the ESD discharge coating may occur in a non-participating environment, such as a vacuum chamber or in a chamber that has been flushed with a non-participating gas, such as an inert gas such as neon or argon, or a non-oxidizing gas, such as carbon dioxide. The coating process may be followed by one or more steps of post-process heat treatment. Depending on the nature of the alloy from which the work piece is formed, heat treatment may be employed to promote a precipitation hardening effect.

More generally, it can be said that in its various embodiments and examples, the surface treatment discussed herein employs an electrically conductive material in the workpiece, and an electrically conductive material for deposition. That material may be a metal alloy material. It may be applied to a metal, or metal alloy as suitable. It may be applied to weldable semi-conductor alloys or to weldable metal-based composites such as Titanium Carbide and Titanium di-Boride. It contemplates that either or both of the work piece and the welding electrode rod material for deposition in various embodiments is, or are, of a material or alloy of material that includes at least one of (a) Nickel; (b) Chromium; (c) Molybdenum; (d) Titanium; (e) Tungsten; (f) Iron (g) Steel (h) Aluminum and Aluminum alloys; and (i) Niobium.; (j) Magnesium; and (k) Cobalt. The material may also include one or more of Carbon, Cobalt, Manganese, Vanadium, or other metals that may be found in steel alloys, Nickel-based alloys, Aluminum alloys or Copper alloys. In some cases, the work piece may be made of a metal alloy of which Nickel, Chromium, and Iron are the largest constituents by wt. %. In some alloys it is more than 40% Nickel, and more than 10% Chromium, two constituents being the primary constituents of the alloy and forming a majority of the material.

In some instances the coating material is formed of an alloy that, by weight, has a higher percentage of Nickel than any other constituent. It may be nearly pure Nickel, i.e., more than 90% by weight. In other embodiments the coating material is made of a metal alloy of which Iron is the largest constituents by wt. %. In other embodiments the coating material is made of a metal alloy of which Cobalt is the largest constituents by wt. %. In still others the coating material is made of a metal alloy of which Titanium is the largest constituents by wt. %. Ultra high purity argon shielding gas can be delivered coaxially around the electrode during deposition, and ESD parameters of 100 V, 80 µF and 150 Hz can be used. The method could have an initial discharge voltage in the range of 30 to 200 V.

Once an ESD coating has been applied, additional layers or sub-layers may be added whether of the same composition or a different composition. These processes may be undertaken with relative control over the area and size of the weld, and of the total energy input in the weld. The total energy input may be set according to the surface area of the weld to be made, and the thickness of the material of the weld.

In operation, the output switching of the power supply is controlled by a main control unit of the power supply. Although synthetic DC electrical signals, or electrical pulses, however they may be called, may not have the same period or pulse duration, they may have an average rate of discharge, or an accumulated number of signals per elapsed unit of time. For example, there may be 10 to 10,000 signals, or discharges, over a period of 1 second. In some embodiments this rate may be in the range of 1500 discharges per second to 5000 discharges per second. This can be termed a frequency range of 10 Hz to 10 kHz, except that the individual pulses are not cyclic, but rather are discrete, programmed, DC discharges. The operator may program the power supply by adjusting the discharge voltage levels, and the overall energy discharge per unit time (effectively, the pulse voltage, total charge, and the number of pulses per second) to govern the overall heat input into the workpiece interface (e.g., to avoid over-heating). However, once having set those external input parameters, the main control unit is programmed electronically to implement the selections made by the operator.

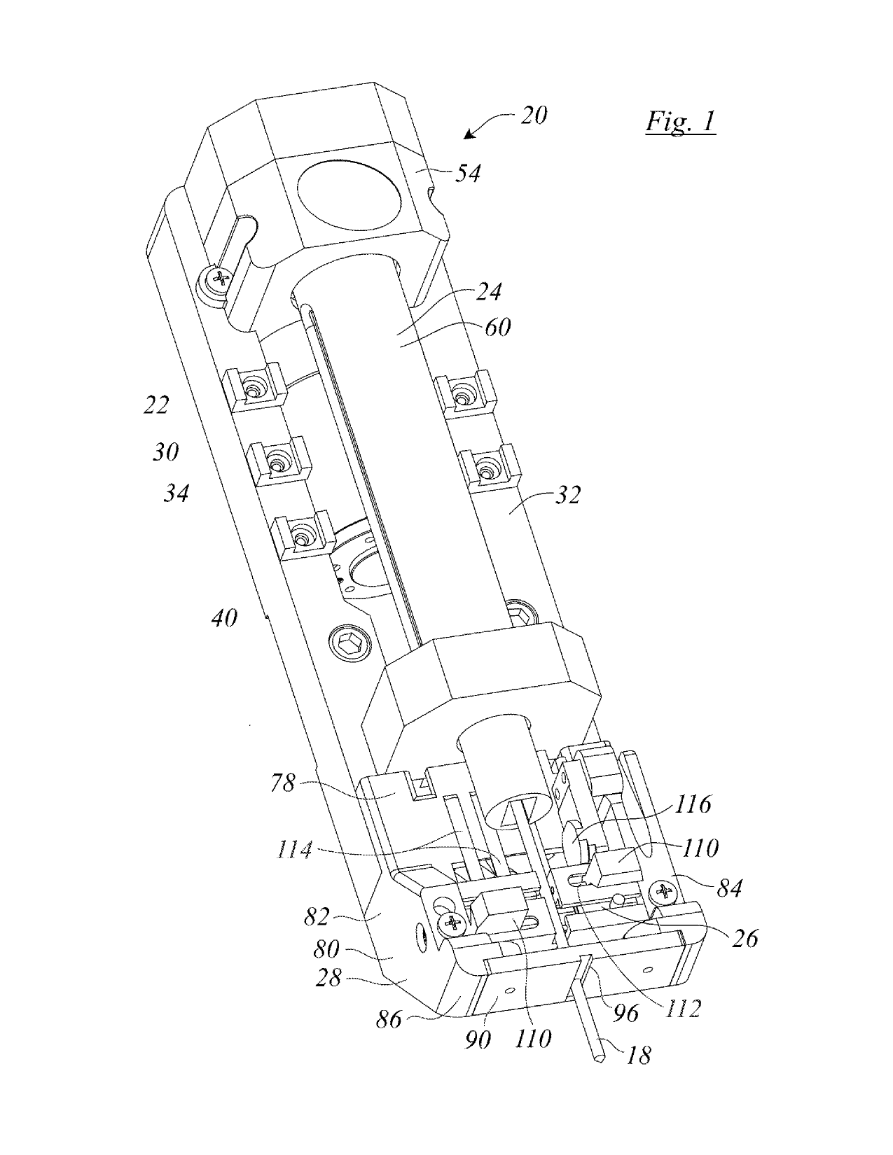

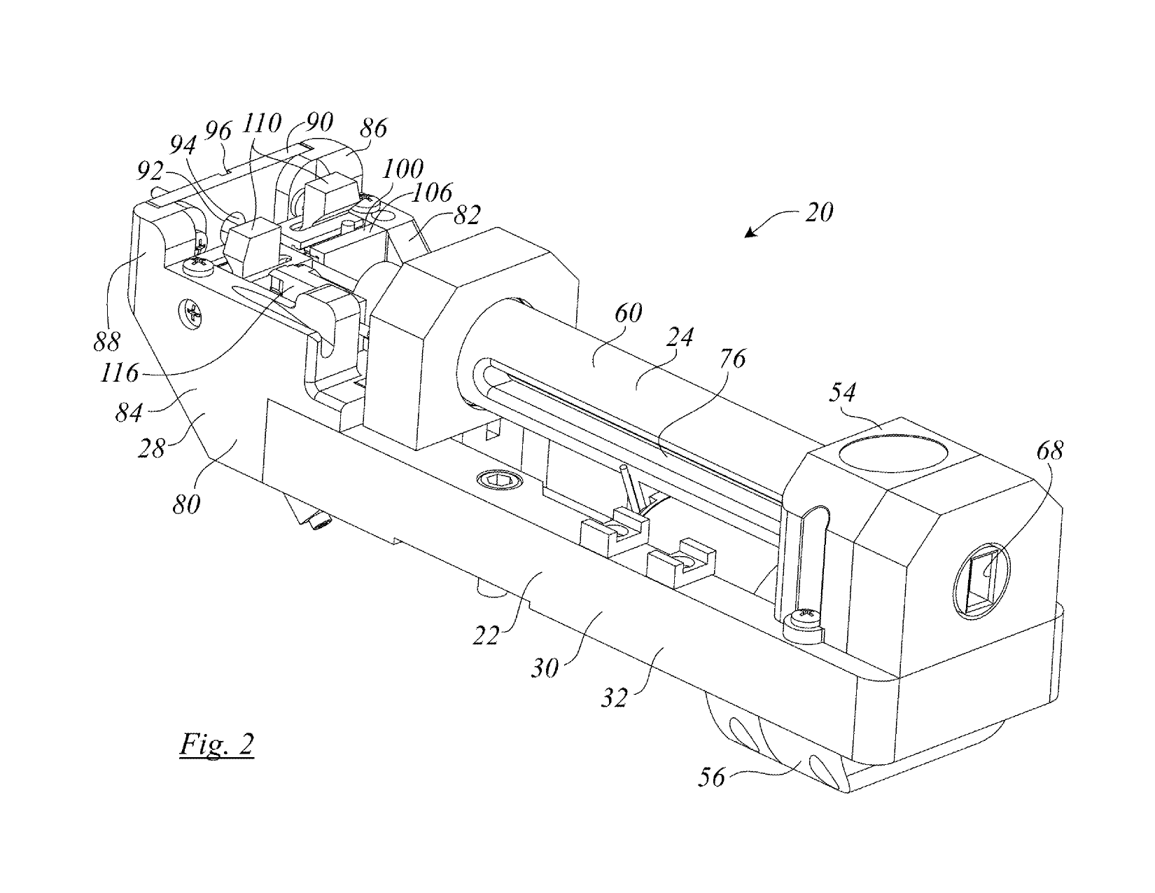

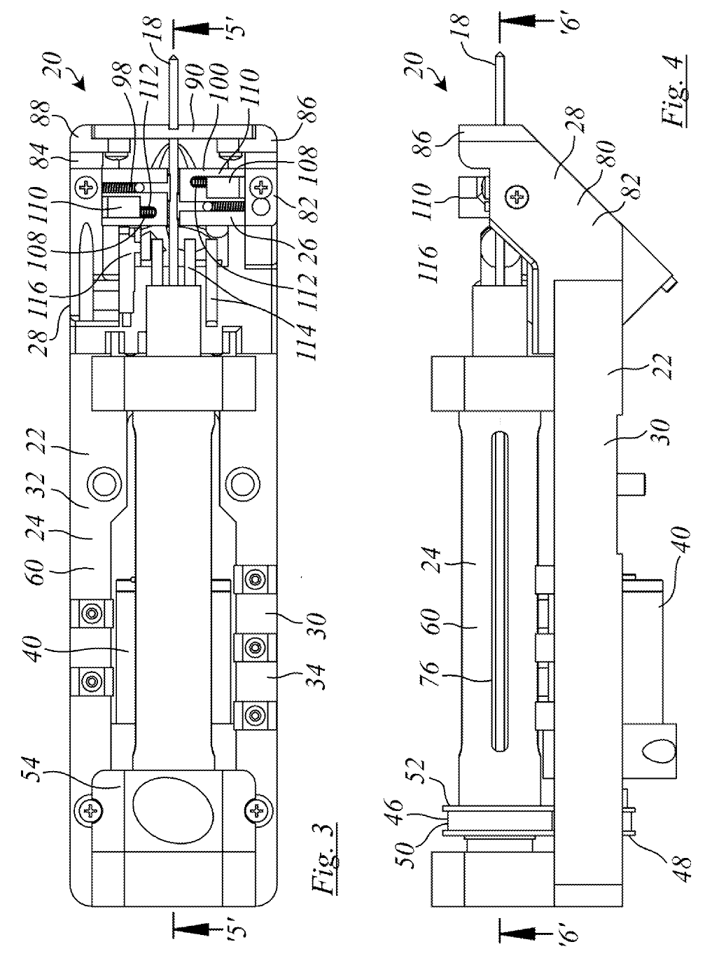

A welding apparatus is shown in perspective view in FIGS. 1 through 6 generally as 20. As explained above welding apparatus 20 may be understood to be a low-energy welding apparatus, such as an ESD apparatus. It may be used for welding or coating on an automotive assembly line, or in an industrial welding process more generally. Welding apparatus 20 may typically be opposed by a co-operating welding head, or by a base work-piece that is connected to an opposite pole of the power supply. In operation, a welding head such as welding apparatus 20 may be understood to be mounted to a robot. A workpiece is presented to the robot. The robot presents the welding head and then causes it to follow a path along which deposition of weld metal material is to occur. When an electrical current is applied, and arcing occurs, deposition of weld metals will take place. It is somewhat arbitrary whether the welding apparatus moves, or the workpiece moves, or both are movable.

Welding apparatus 20 has a stationary base, or stator, or chassis 22; a rotor, or torque transmission or spindle or yoke assembly, which may simply be referred to as yoke 24; and an electrical transmission 26. In use, a consumable welding rod 18 is carried by yoke 24 and progressively advanced past or through electrical transmission 26. Chassis 22 may be a main body member. It has a bed or frame 30 and a head or foot 28 that is rigidly mounted to frame 30. Frame 30 may typically be made of steel or by a molded plastic of substantial stiffness. Frame 30 has a pair of first and second side beams, or frame rails 32, 34. There is a forward cross-member 36, and a rear cross-member 38. Frame rails 32, 34 extend parallel to the axis of rotation of welding rod 18, and cross-members 36 and 38 extend transversely to that axis. Rails 32, 34 and cross-members 36, 38 co-operate to form a rectangle that is the basic structure of frame 30.

Yoke 24 may be thought of as a spindle shaft. It is carried in a pair of bearings, which are identified as the first bearing or front bearing 42, and a second bearing or rear bearing 44. The front bearing is the bearing that, in use, is closest to the workpiece. The rear bearing is then the bearing that is more distant from the workpiece. The nomenclature “front” and “rear” is arbitrary. A motor 40 is mounted to frame 30. Although gearing or other devices could be used to permit other orientations, it is convenient for motor 40 to be mounted such that the axis of rotation of motor 40 is parallel to the axis of rotation of welding rod 18. While other orientations are possible, and while orientation may change during operation of the robot, it is likewise convenient to think of motor 40 as being underslung in its mounting to frame rails 32, 34.

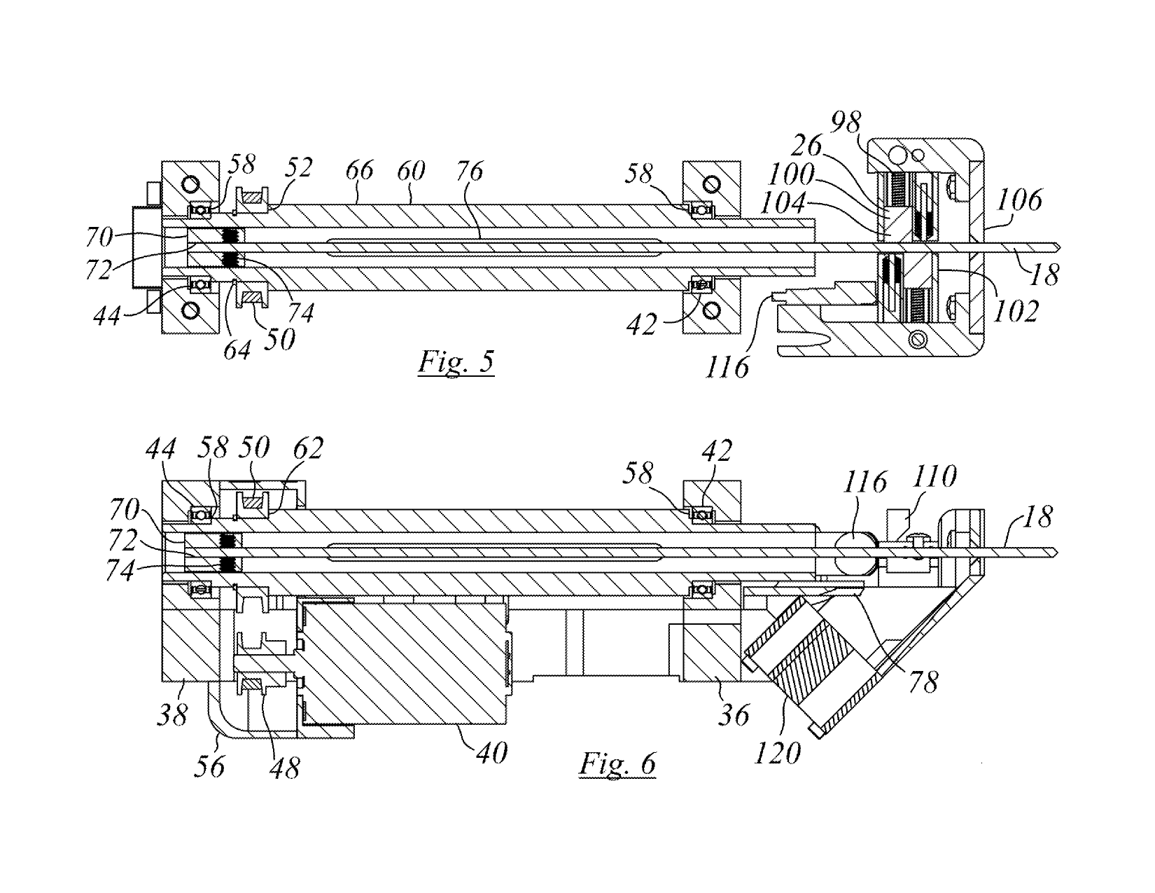

There is a transmission drive link, which is indicated generally as a flexible drive 46, that connects the output motion of motor 40 to yield the input motion to the spindle, or yoke, 24. While gears or shafting could be used, in this case motor 40 has an output wheel, or sheave, or pulley 48, and spindle, or yoke 24 has an input wheel or sheave, or pulley 52. They are linked together by a transmission member, which could be a chain or cable or belt such as V-belt 50. In the example, V-belt 50 may be a timing belt. Inasmuch as motor output pulley 48 may be of a different diameter than input pulley 52, i.e., typically output pulley 48 is smaller than input pulley 52, there is a rotational speed change from motor 40 to spindle or yoke 24, which may be, and as shown is, a speed reduction. As may be understood, in the side view of FIG. 4 and in the sectional views of FIGS. 5 and 6, the upper drive cover 54 and lower drive cover and motor mount housing 56 have been removed to permit the elements of flexible drive 46 to be seen.

As indicated previously, the spindle or yoke 24 is carried in respective first and second, or front and rear, bearings 42, 44 which are themselves mounted to frame rails 32, 34. The major element of spindle or yoke 24 is a tube or shaft 60. Tube or shaft 60 is hollow. Shaft 60 may be made of a non-electrically conductive material, such as a ceramic insulator, or Bakelite (t.m.), as may be appropriate. It may have relatively thick walls. The forces applied to shaft 60 in transmitting torque to welding rod 18 are quite modest such that a ceramic or other non-conductive material can be used, or a non-conductive sleeve may be mounted within shaft 60 to define the bore. To the extent that shaft 60 or chassis 22 are non-conductive, or have a non-conductive barrier, welding rod 18 cannot find ground through them, and electrical current is not passing through bearings 32, 34, which might otherwise degree bearing life prematurely.

The ends of shaft 60 have been turned, or otherwise reduced in diameter to yield external shoulders 58 that slide into bearings 42, 44 respectively. Similarly, shaft so has a further, larger shoulder 62 that receives input pulley 52. Shoulder 62 can be at either end of shaft 60. It is convenient that it be located at the distal end, as illustrated. Pulley 52 is keyed to shaft 60, whether by spines, or a keyway, or by the use of a radially driven grub screw or cotter pin such as may permit pulley 52 to transmit torque to shaft 60. Pulley 52 is held in place axially by a spring clip 64 or similar feature.

As noted, shaft 60 is hollow. It has a central bore 66. Bore 66 is cylindrical. However, while smooth and cylindrical in the axial direction, it also has, or defines a torque transmission interface, indicated as 68. A cross-head 70 rides within bore 66 like a piston in a cylinder. There are many ways to transmit torque from an external drive to an internal sliding cross-head. Splines or keyways, or flats, or any non-purely circular profile could be used, for example. Interface 68 may be polygonal, as in the embodiment illustrated it which bore 66 is square or rectangular, and cross-head 70 is similarly square or rectangular so that it fits in a close, but loose enough internal fit to permit axial sliding. In this context, bore 66 defines a guideway, or track, or pathway, or path, and cross-head 70 defines a follower. The follower engages the guideway and is restrained to follow the path. As such, there is a single degree of freedom of the follower (and so also of electrode rod 18) relative to the path, namely axial translation, i.e., toward the workpiece. This occurs while both the guideway and the follower are moving in a second degree of freedom, namely rotation about the welding rod axis, relative to the contact point with the workpiece at the tip of welding rod 18. Of course, while this is occurring, the robot to which welding apparatus 20 is mounted may in general be following a pre-programmed path that may typically lie in the plane of a surface of the workpiece, or, as when the workpiece is an airfoil, the process may involve the robot following a path in 3-space.

Cross-head 70 has a central bore 72 and a locking fitting identified as a securement 74. Bore 72 is of a diameter to admit the end of welding rod 18 in close fitting relationship. Securement 74 is operable to hold welding rod in axially fixed relation to cross-head 70, and thereby to transmit torque from cross-head 70 to welding rod 18. Securement 74 may have the form of a collet, or clamp, or, as illustrated, a pair of radially driven grub screws. As may be understood, a supply of welding rods may be prepared ahead of time with cross-heads 70 attached. The supply may be provided in a rack or tray, such that replacement rods are pre-mounted with cross-heads, awaiting installation.

Spindle or yoke 24 may have an aperture, or set of apertures 76. Aperture, or apertures, 76 function as a sight glass. Aperture 76 is a long, relatively narrow opening extending axially along shaft 60. As shaft 60 is driven in rotation, the operator can see the axial position of cross-head 70 during much of the time. At the beginning, cross-head 70 cannot be seen, but welding rod 18 can be seen, which indicates that the supply is ample. For most of the time, the position of cross-head 70 will be visible somewhere along the viewing window. When neither cross-head 70 nor welding rod 18 is visible, it means that cross-head 70 is near the end of its travel toward the workpiece, and it is time to be ready to install a new welding rod. Inasmuch as shaft 60 is spinning at about 1000 r.p.m., and given that there are apertures 76 on opposite sides of shaft 60, like a movie projection, there will appear to be substantially constant viewing through shaft 60. There could be more than two apertures 76 – there could be four or six, or there could be a frame lattice of openings.

Head or foot 32 of chassis 22 may, again, include a body 80 made of non-electrically conductive material that is rigidly mounted, joined, connected or otherwise attached to frame 30 in a rigid, known position. Body 80 may be a molded or machined part. As may be appreciated, body 80 is trimmed back such that the end of body 80 at the workpiece end of welding rod 18 is smaller so that the robot can advance welding rod 18 into smaller spaces. In the example, body 80 is relieved at an angle of about 45 degrees as shown in FIGS. 4 and 6.

Body 80 has a pair of left and right-hand mounting pedestals, or cheek plates, or cheeks 82, 84 and a cross-wise extending plate or transom 78 linking cheeks 82, 84 together. The forward extending portions of cheeks 82, 84 can be thought of as a pair of fingers, or legs 86, 88.

A guide plate 90 spans the space between legs 86, 88. Guide plate 90 has an aperture 92 formed therethrough. Aperture 92 defines a forward guide that co-operates with cross-head 70 to provide the end supports, or reactions, of welding rod 18. As welding rod 18 is consumed, the space between cross-head 70 and aperture 92 decreases until cross-head 70 emerges from shaft 60. The inside edge of aperture 92 is generously relieved, as indicated by chamfer 94 and there is a further slot 96 in the front face of guide plate 90 such that the width of aperture 92 in the axial direction is reduced at the 12 o’clock and 6 o’clock positions.

Immediately behind guide plate 90 there is a brush block modules 100 that are part of the system of electrical transmission 26. Module 100 has a pair of brush sets mounted in opposition to each other between legs 86, 88. These brush sets define the electrical current interface between apparatus 20 and welding rod 18. The respective brush sets include first and second electrical contacts that, in use, engage welding rod 18, those contact members being identified as a first brush 102 an and a second brush 104. Each brush is biased toward welding rod 18 by a spring 98 that is captured within housing 106 of brush block module 100. Beside first brush 102 and second brush 104 there are respective push-pin assemblies 108 opposite brush 102 and brush 104). Each push pin assembly has a spring biased pin 112 that is axially aligned with the respective brush it opposes, and a handle or tab 110 that rides in a slot in the top of brush block module 100. Tabs 110 stand proud of housing 106, and permit an operator manually to compress the respective spring of each spring biased pin 108, thereby retracting that pin 108. As may be understood, brushes 102 and 104 are offset from each other in the axial direction. During operation, push pins 108 provide a roughly symmetrical reaction to the spring loading of brushes 102, 104 in the radial direction. Brushes 102, 104 are commercially available brushes, such as may be found in power tools such as drills, routers, and so on. Brushes 102, 104 are rectangular in section, being wider than thick. The width extends in the axial direction of welding rod 18. The thickness extends cross-wise to welding rod 18. The thickness is less than or equal to the diameter of welding rod 18. That is, whereas welding rod 18 may typically be 4 mm in diameter, the thickness of brushes 102, 104 may be about 1/8” diameter, which is slightly less than 4 mm. As may be understood, brushes 102, 104 are connected to the power supply to receive the output electrical discharges of the ESD welding process, and to carry those pulses into welding rod 18. As may also be understood, the diameter of push pin 108 is smaller than the axial extent of the width of brushes 102, 104.

There may be, and in the apparatus illustrated there is, a cooling fan installation under transom 86. The cooling fan 120 is mounted centrally between cheeks 82, 84, and shy of the relieved chamfer of body 80 more generally. Fan 120 provides airflow to cool brushes 102, 104 and the leading end portion of welding rod 18. To that end, there is an open space between the back face of guide plate 90 and the leading edge of transom 78. Transom 78 also has a set of fingers 114 that extend forwardly toward brushes 102, 104. Fingers 114 define an airflow grid, and also define a trap or catchment that receives cross-head 70 when it emerges from the front end of shaft 60. That is, the spacing between fingers 114 admits the passage of cooling airflow from fan 120, while fingers 114 prevent cross-head 70 from falling into fan 120 when it is time to change welding rod 18. That catchment is open on the top, and the catchment and the opening provides the access, or escape, by which used welding rods 18 may be caught and removed.

A sensor 116 is mounted to one or the other of cheeks 82, 84 (in the example illustrated, sensor 116 is mounted to cheek 84). Sensor 116 may be an optical sensor, or it may be sense capacitance or such other property as may be suitable. In the example illustrated, sensor 116 is an optical sensor. Sensor 116 is mounted to look across body 80 toward the other cheek. When cross-head 70 becomes visible, it will begin to obstruct sensor 116, and thereby to change its signal state. When this occurs, the robot retracts welding apparatus from the work piece, and waits for the operator to change out the consumed welding electrode rod 18 for a new welding electrode rod 18. When that happens, the operator moves cross-head 70 slightly forward until it clears the end of shaft 60. When that occurs, chamfer 92 and slot 94 make it possible for the remainder of old rod 18 to be angled as cross-head 70 is extracted upwardly out of head 26.

The new electrode is introduced through the rear, or distal, end of shaft 60, and fed forward. When the forward tip of the new welding rod 18 reaches brush 104, the opposed push pin is pushed forward to push brush 104 out of the path of welding rod 18. When welding rod 18 meets the first push pin, it is released and drawn back, and brush 104 then bears against the opposite side of welding rod 18. Welding rod 18 is then advanced until it contacts the rear side of brush 102, and the process is repeated. Once past brush 102, the new welding rod 18 is then fed forward past guide plate 90, and set at a calibration distance, as suitable. Once installed, the radial forces of the brushes and push pins are roughly balanced, and the tool is ready to resume operation.

Customarily, in operation the tip of welding rod 18 at the location of engagement of the workpiece is lower than cross-head 70. As such, the weight of welding rod 18 and cross-head 70 tend to urge welding rod 18 toward (and to engage) the workpiece. This tendency is resisted by the friction in brushes 102, 104 and their respective opposed push pins, and by whatever friction there may be between cross-head 70 and shaft 60. However, in operation, the rotation of shaft 60 and welding rod 18 tends to introduce vibration into the system. In an ESD process a motor such as motor 40 (or another independent motor) may be used intentionally to drive an imbalance oscillator. This may be done for the purpose of introducing a forcing vibration as between welding rod 18 and the workpiece, as a randomness in making and breaking contact with the workpiece is sometimes, if not often, desired in the making of ESD coatings, as also may be a peening effect of impacting still-plastic deposited ESD material during the non-discharge dwell time between successive discharges. In any event, the presence of vibration may tend to eliminate, or overcome, the friction forces in the assembly, such that the constant force of gravity may tend to urge welding rod 18 to continue to engage the workpiece, and, consequently, for cross-head 70 to advance in shaft 60 as welding rod 18 is consumed.

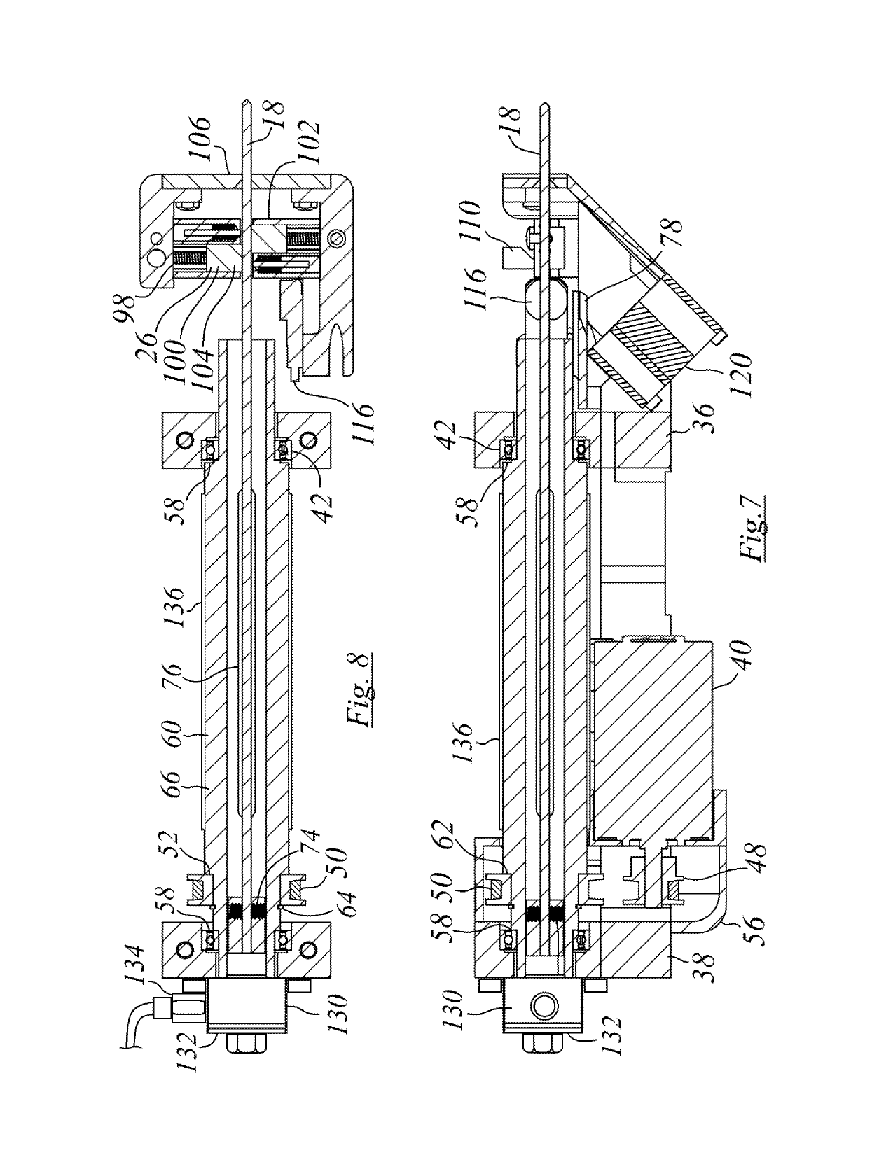

However, it may be that it may be desired to apply an ESD coating to an object to make a weld in which gravity may not necessarily urge welding rod 18 toward the workpiece. To that end, in the alternate arrangement of FIG. 7, the rear end of shaft 60 is covered by a further cap 130 that is mounted to motor-mount housing 56. Cap 130 has a movable port 132 that is opened when replacing welding rod 18, and that is of a size to admit passage of cross-head 70. Cap 30 also has an air inlet coupling 134. Additionally, shaft 60 may have an external transparent sleeve 136 such that visibility of cross-head 70 through apertures 76 is preserved, but escape of airflow through apertures 76 is obstructed. Cap 130 may have a pressure relief, which may be formed integrally with or as part of movable port 132. The air pressure required to bias cross-head 70 to move in the manner of a piston inside the cylindrical path defined inside hollow shaft 60 is modest, of the order of 15 to 30 inches of water (roughly ½ to 1 psig, or 3.5 to 7 kPa), or possibly less, depending on the angle of inclination and the density of the alloy of welding rod 18. For a welding rod 18 of pure copper, between 15 and 18 inches long, and 4 mm in diameter (roughly 5/32”), with a cross-head 70 attached, the total mass is about 500 g, corresponding to a weight of roughly 1 lb, or a bit more. For a cross-head 70 that is roughly 1-1/2” in diameter (38 mm), and the desirability of a contact force on the workpiece of roughly 3 N (2/3 of a lb.), the pressure required to bear vertically is less than 1 psig. These are modest values. Accordingly, leakage past cross-head 70 or port 132 and may help to flush dust and welding soot out of the apparatus, which may be beneficial. The pressure level is adjustable according to the weight of the alloy being used, and the angle of inclination.

It may also be noted that in existing ESD applicators, the total current resistance decreases as the short 3 or 4 inch long welding electrode rod is consumed. Where the electrode rod is made of a relatively pure metal such as Nickel, this may make little difference, and may be tolerable. However, ESD is often chosen where the object of the process is to lay down a coating of a material that would be difficult to weld by other, more conventional procedures. Those processes often involve the use of non-standard alloys, or ceramic composite alloys. Those alloys may have substantial electrical resistance, and may sometimes tend to behave like semi-conductors. In such instances, the welding electrode rod may be the major resistance element in the circuit from the power supply to the work piece. The change in the resistance as the rod is consumed may therefore also be substantial as a portion of the original total resistance. Where the reduction in resistance is comparatively large, it may affect the rate of deposition per discharge, and consequently the consistency of quality of the process.

In the apparatus and process described herein, welding rod 18 is 15 – 18 inches long, and as such is 4 or 5 times the usual length of an ESD welding rod. The remainder when the rod is consumed may be about 2 – ½ inches or 3 inches long, meaning that 80% - 85% of the material is being used, as opposed to 65% - 75% of an existing short rod. Existing rods may take 5 to 10 minutes to be consumed. Depending on the process parameters, the longer rods described herein may take 40 – 50 minutes to be consumed. This means that the robot can work on coating the workpiece four or five times as long with having to interrupt work for replacement of the welding rod. In such a process, if a welding rod 15 – 18 inches long were used with an electrical connection at the far end of the rod, the resistance in the rod, and the heating in the apparatus itself, might be quite substantial, and the reduction in resistance in the circuit over the length of time the rod is in use as it is being consumed could also be quite high.

However, in the apparatus described, the electrical current path distance from the input current location at brushes 102, 104 to the tip of welding rod 18 at the point of contact with the workpiece is constant. That is, however much of welding rod 18 remains to be consumed, the electrical resistance attributable to welding rod 18 as a proportion of total resistance in the electrical discharge circuit is constant. There is no other electrical discharge path, given that shaft 60 is isolated from finding electrical ground anywhere else, and guide plate 90 is likewise held in an electrically isolated mounting in legs 86, 88. As such, the grip that holds ESD welding rod 18, and the carriage defined by shaft 60 in which welding rod 18 is caused to spin are isolated from electrical ground (or, really, the return electrical path to the power source) other than through welding rod 18 and the workpiece. There is no other electrical path through which electrical charge or electrical current can escape (or be supplied), and, consequently, there is no electrical current flow through those elements, and the resistance seen by the power supply in releasing charge pulses through welding rod 18 is constant, or close enough to be considered constant. Although the parameters of discharge may still need to be calibrated and adjusted according to the nature of the alloy being used, once those parameters have been set, they may not need to be adjusted during processing as rod 18 is consumed because its contribution to resistance to current flow is then constant, or substantially constant.

Although the present description is provided in the context of first and second window sub-assemblies that combine to form a larger assembly that fills the window envelope or accommodation formed in the door panel, it will be understood that such an assembly could employ additional window extensions, as may be.

We claim:

1. A welding electrode holding apparatus operable to accommodate advance of an ESD welding electrode rod during operation on a workpiece, said welding electrode apparatus comprising:
a head and a carriage mounted co-operably with said head;
the carriage having a grip in which to secure an end of an ESD welding electrode;
the carriage defining a pathway;
said grip being movable relative to said pathway, and being constrained to follow said pathway;
a drive mounted to rotate said carriage;
said carriage being operable to transmit rotation to said grip and thereby to the ESD welding rod when the ESD welding rod is mounted in the grip;
said head having a guide that admits passage of the ESD welding rod; and
said head having a first brush through which electrical current from a power supply is passed to the ESD welding rod.

2. The welding electrode holding apparatus of claim 1 wherein said carriage is supported in a pair of spaced apart bearings permitting rotation thereof about an axis or rotation, and, during operation, said grip is able to translate axially relative to said axis of rotation.

3. The welding electrode holding apparatus of claim 2 wherein said head has a second brush, said first and second brushes being opposed and being mounted to engage the ESD welding rod.

4. The welding electrode holding apparatus of claim 3 wherein there is a respective push pin mounted in opposition to each said brush.

5. The welding electrode holding apparatus of claim 1 wherein said guide is electrically isolated other than through contact with the ESD welding rod.

6. The welding electrode holding apparatus of claim 1 wherein said apparatus includes a sensor mounted to detect an end of travel advance of the ESD welding rod.

7. The welding electrode holding apparatus of claim 1 wherein said apparatus is biased to urge the ESD welding rod axially toward a workpiece while being rotated in said carriage.

8. The welding electrode holding apparatus of claim 1 wherein said apparatus includes a sight-glass to permit visual observation of consumption of the ESD welding rod during processing.

9. The welding electrode holding apparatus of claim 1 wherein at least one of:
(a) said brush lies between said carriage and the workpiece; and
(b) said brush lies between said carriage and said guide.

10. The welding electrode holding apparatus of claim 1 wherein when said apparatus is higher than the workpiece, the apparatus is biased by gravity to advance the welding rod, and said apparatus has a sensor operable to identify when the ESD welding rod requires replacement.

11. The welding electrode holding apparatus of claim 1 wherein said apparatus has a sensor operable to identify when the ESD welding rod requires replacement.

12. The welding electrode holding apparatus of claim 1 wherein at least one of (a) said carriage; and (b) said guide plate, is isolated from electrical ground.

13. The welding electrode holding apparatus of claim 1 wherein said apparatus includes a fan operable to provide ventilation to said brush.

14. An ESD welding apparatus in which to mount an ESD welding rod for deposition of material on a workpiece, wherein said apparatus has an electrical current path length through the ESD welding rod to the workpiece that is constant notwithstanding incremental consumption of the ESD welding rod.

15. The ESD welding apparatus of claim 14 wherein, in operation, electrical resistance in the welding rod is constant.

16. The ESD welding apparatus of claim 14 wherein said apparatus includes a rotating mounting for the welding rod, said rotating mounting being isolated from electrical ground.

17. The ESD welding apparatus of claim 14 wherein said apparatus includes a carriage and a set of brushes; in use the welding rod advances through the carriage toward the workpiece, and the set of brushes engage the welding rod at a location between the carriage and the workpiece.

18. The ESD welding apparatus of claim 17 wherein said apparatus includes an escape by which to extract the remainder of the ESD welding rod after consumption of a predominant portion thereof; the escape being located between the carriage and the workpiece.

19. A method of ESD deposition of welding material from an ESD welding rod on a workpiece, wherein said method includes maintaining a constant electrical current length in the ESD welding rod while it is being consumed.

20. The method of ESD deposition of claim 19 wherein said method includes spinning the ESD welding rod in a carriage, the carriage having a grip therein that fastens to the ESD welding rod, and the grip being otherwise isolated from electrical ground.
